(19) United States
(12) Patent Application Publication
(10) Pub. No.: US 2025/0321612 A1
(43) Pub. Date: Oct. 16, 2025

(54) TIME SYNCHRONIZATION BETWEEN CHASSIS COMPONENTS

(71) Applicant: Dell Products L.P., Round Rock, TX (US)

(72) Inventors: Parminder Singh Sethi, Ludhiana (IN); Pandiyarajan Mani, Gudiyattam (IN); Veena Ramarao, Bangalore (IN)

(21) Appl. No.: 18/634,572

(22) Filed: Apr. 12, 2024

(51) Int. Cl. G06F 1/12

(52) U.S. Cl. CPC G06F 1/12

(57) ABSTRACT

A method comprises collecting time configuration data from respective ones of a plurality of components of a chassis, analyzing the time configuration data to determine whether at least two components of the plurality of components have different time configurations from each other, and generating a time configuration profile in response to determining that the at least two components have different time configurations from each other. The time configuration profile is propagated to the plurality of components, wherein the plurality of components are configured to respectively apply the time configuration profile to synchronize time settings between the plurality of components.

### FIELD

The field relates generally to information processing systems, and more particularly to component management in such information processing systems.

### BACKGROUND

The multiple components of a chassis may have different timing configurations, which can present a number of challenges. One such challenge is chassis communication failures. Because of timing configuration mismatches between different chassis components, many internal communications of a chassis can result in critical failures such as, for example: (i) firmware update failures for the chassis components; (ii) problems with inventorying chassis components; (iii) issues with job scheduling for the chassis components; and (iv) difficulties with correlating events and/or logs, since the log order of the components will differ based on differently configured times (e.g., time zones). Another such challenge is security loopholes. For example, a lack of time synchronization between chassis components can lead to internal and external cyber-attacks by facilitating hacker access to an infrastructure and its data.

### SUMMARY

Illustrative embodiments provide a platform and techniques to provide time synchronization between chassis components.

For example, in one embodiment, a method comprises collecting time configuration data from respective ones of a plurality of components of a chassis, analyzing the time configuration data to determine whether at least two components of the plurality of components have different time configurations from each other, and generating a time configuration profile in response to determining that the at least two components have different time configurations from each other. The time configuration profile is propagated to the plurality of components, wherein the plurality of components are configured to respectively apply the time configuration profile to synchronize time settings between the plurality of components.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts an information processing system comprising a platform for implementing a common time configuration between chassis components, according to an illustrative embodiment.

FIG. 2 depicts an operational flow for communication between chassis components, according to an illustrative embodiment.

FIG. 3 depicts a screenshot of a user interface for viewing and/or configuring time settings of a management service module (MSM), according to an illustrative embodiment.

FIG. 4 depicts a screenshot of a user interface for viewing and/or configuring time settings of a remote access controller (RAC), according to an illustrative embodiment.

FIG. 5 depicts a screenshot of a user interface for viewing and/or configuring time settings of a host device operating system (OS), according to an illustrative embodiment.

FIG. 6 depicts a screenshot of a command line interface (CLI) for viewing and/or configuring time settings of an embedded controller (EC), according to an illustrative embodiment.

FIG. 7 depicts an operational flow for generating and sending notifications of time protocol misconfigurations for different chassis components, according to an illustrative embodiment.

FIG. 8 depicts a workflow for identification and remediation of time protocol misconfigurations between different chassis components, according to an illustrative embodiment.

FIG. 9 depicts a process for implementing a common time configuration between chassis components, according to an illustrative embodiment.

FIGS. 10 and 11 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous and a user device receives messages without any significant time delay. Of course, it should be understood that depending on the particular temporal nature of the system in which an embodiment is implemented, other appropriate timescales that provide at least contemporaneous performance and output can be achieved.

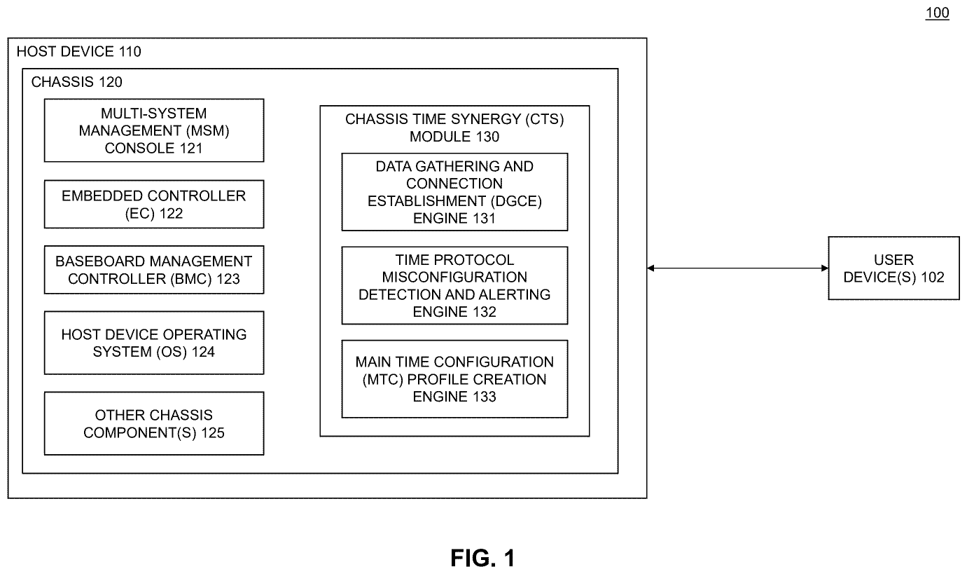

FIG. 1 depicts an information processing system 100 comprising a host device 110 including a chassis 120 comprising chassis components such as, for example, a management service module (MSM) console 121, an embedded controller (EC) 122, a baseboard management controller (BMC) 123, a host device operating system (OS) 124 and one or more other chassis components 125 (e.g., expansion cards, disk drives, power supply units, central processing units, graphics processing units, memories, etc.). The chassis 120 further includes a chassis time synergy (CTS) module 130. The CTS module 130 includes a data gathering and connection establishment (DGCE) engine 131, a time protocol misconfiguration detection and alerting engine 132 and a main time configuration (MTC) profile creation engine 133.

The MSM console 121 is a web-based chassis management console that utilizes a user interface (UI) which provides access for a user to perform chassis-related deployment, configuring, management and monitoring tasks. For example, blade server deployment and configuration deployments can be controlled via the MSM UI. The MSM UI provides access for a user to configure multiple installed components in a chassis. The EC 122 is a chassis component responsible for performing tasks such as, for example, bare metal deployment, monitoring, logging, inventory management, power management, thermal management, fan profiling, etc. In illustrative embodiments, the EC 122 may have its own operating system, which works in command-line interface (CLI) mode and provides required data and access to the MSM console 121 and MSM UI. Access to the EC 122 can be limited to developers and support team members for debugging; however, some of these actions may be performed using the MSM UI.

In illustrative embodiments, the BMC 123 is a system on check (SoC) device, which provides individualized access to enterprise servers. The BMC 123 enables performance of actions such as, for example, deployment management, inventory management, power management, thermal management, etc. The BMC 123 comprises a specialized processor that monitors the physical state of the host device 110 or other hardware. The BMC 123 may use one or more sensors (not shown) to measure parameters such as, for example, temperature, humidity, power-supply voltage, fan speeds, communications parameters and functions of the host device OS 124, and other operating systems associated with the host device 110. The BMC 123 can be part of an intelligent platform management interface (IPMI) and may be a component of the motherboard or main circuit board of the host device 110.

A non-limiting example of a BMC 123 is a remote access controller (RAC) such as, for example, an integrated Dell® RAC (iDRAC). An iDRAC allows information technology (IT) administrators to monitor, manage, update, troubleshoot, and remediate the host device 110 (e.g., server) out-of-band from any location without the use of agents. The BMC 123 includes hardware and software that provide a variety of features including, but not necessarily limited to, device management, monitoring, power cycling, authentication, data collection and data analytics.

The host device OS 124 comprises, for example, Windows®, Linux®, VMWare®, RedHat® or other type of operating system. The host device 110 further includes a basic input/output system (BIOS) (not shown), a BIOS non-volatile random-access memory (NVRAM) (not shown) or other persistent storage of the BIOS. In a non-limiting illustrative example, the BIOS can be in the form of firmware and/or software which includes a program that starts a computer system after it is powered on, and manages data flow between a computer's operating system (e.g., host device OS 124) and attached devices, such as, for example, a hard disk, video adapter, keyboard, mouse, printer, etc. The BIOS can be embedded on a memory chip on a system board or motherboard of the host device 110, and function as an interface between hardware of the host device 110 and the host device OS 124.

Network Time Protocol (NTP) is an Internet protocol used to synchronize components with computer clock time sources in a network. The multiple components of a chassis may have different NTP configurations, which, as noted herein above, can lead to issues with security, updates, inventorying, job scheduling and event and/or log correlation.

In an attempt to address the above technical problems, the illustrative embodiments advantageously provide a platform for implementing a common time configuration between chassis components. The platform includes the CTS module 130, which causes chassis components to have identical time configurations (e.g., identical NTP configurations). The CTS module 130 collects and analyzes time configuration data of chassis components such as, for example, the MSM console 121, EC 122, BMC 123, host device OS 124 and other chassis components 125 and creates an MTC profile to establish the identical time configurations for each of the chassis components. In illustrative embodiments, the CTS module 130 collects current NTP configurations of the chassis components along with time zone details and creates the MTC profile. The MTC profile is automatically propagated to all chassis components (e.g., MSM console 121, EC 122, BMC 123, host device OS 124 and other chassis components 125). In some embodiments, prior to propagation, a user will have an option to modify the configurations in the MTC profile.

The host device 110 is connected to one or more networks to communicate with external devices such as, for example, one or more user devices 102, which may be used by, for example, administrators or customers of an enterprise. The networks comprise at least a portion of a global computer network such as the Internet, although other types of networks can be part of the networks, including a wide area network (WAN), a local area network (LAN), a satellite network, a telephone or cable network, a cellular network, a wireless network such as a WiFi or WiMAX network, or various portions or combinations of these and other types of networks. The networks comprise combinations of multiple different types of networks each comprising processing devices configured to communicate using Internet Protocol (IP) or other related communication protocols.

In a non-limiting illustrative example, some embodiments may utilize one or more high-speed local networks in which associated processing devices communicate with one another utilizing PCIe cards of those devices, and networking protocols such as InfiniBand, Gigabit Ethernet or Fibre Channel. Numerous alternative networking arrangements are possible in a given embodiment, as will be appreciated by those skilled in the art.

The host device 110 illustratively comprises a computer, server or other type of processing device. At least a portion of the host device 110 can be implemented with virtual machines (VMs), containers, etc. The host device 110 and/or components thereof can comprise, for example, a desktop, laptop or tablet computer, server, storage device or other type of processing device. Such a device is an example of what is more generally referred to herein as a “processing device.” Some of the processing devices are also generally referred to herein as “computers.” The host device 110 in some embodiments comprises a computer associated with a particular company, organization or other enterprise.

The terms “user,” “customer,” “client” or “administrator” herein are intended to be broadly construed so as to encompass numerous arrangements of human, hardware, software or firmware entities, as well as combinations of such entities. At least a portion of the available services and functionalities provided by the host device 110 and/or components thereof in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments. Although not explicitly shown in FIG. 1, one or more input-output devices such as keyboards, displays or other types of input-output devices may be used to support one or more user interfaces to the host device 110.

The host device 110 illustratively provides time synchronization services on behalf of each of one or more users associated with the host device 110. The term “user” herein is intended to be broadly construed so as to encompass numerous arrangements of human, hardware, software or firmware entities, as well as combinations of such entities.

The DGCE engine 131 establishes end-to-end communication between all chassis components using, for example, one or more software-based management modules such as OpenManage Server Administrator (MSA) and SupportAssist®, which can be used to collect operational data from the chassis components either on demand, in an alert-based manner, and/or at periodic intervals. In addition to software-based management modules, universal serial bus network interface controller operating system (USB-NIC OS) passthrough communication channels and chassis internal communication channels are used to establish the end-to-end communication between the chassis components (e.g., MSM console 121, EC 122, BMC 123, host device OS 124 and other chassis components 125).

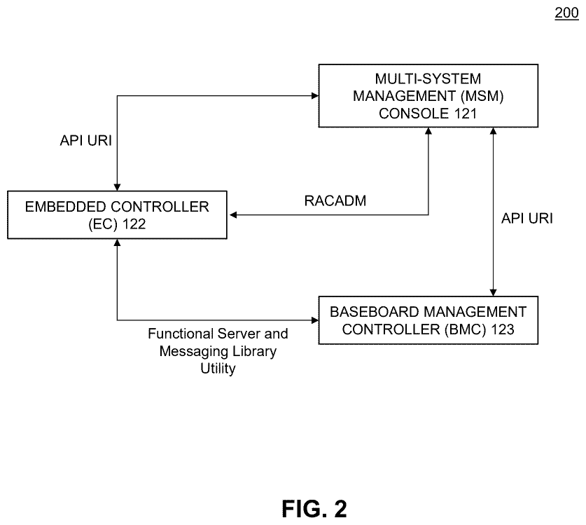

Referring, for example, to the operational flow 200 in FIG. 2, the DGCE engine 131 establishes a communication channel between the MSM console 121 and the EC 122 using, for example, an API uniform resource identifier (URI), such as a Redfish® URI and one or more internal commands. For example, the DGCE engine 131 uses a remote access controller command-line utility for initial configuration setup and troubleshooting between the MSM console 121 and the EC 122. An example of the remote access controller command-line utility is the RACADM command-line utility, which provides a scriptable interface that allows for component configuration. The utility can run on the MSM console 121. In illustrative embodiments, the URI includes a character sequence that identifies logical and/or physical resources to distinguish one resource from another. The DGCE engine 131 also establishes a communication channel between the MSM console 121 and the BMC 123 using, for example, an API URI (e.g., Redfish® URI) and one or more internal commands (e.g., RACADM command-line utility). In this case, the scriptable interface can be used to locally or remotely configure the BMC 123 (e.g., iDRAC). In addition, a command and/or a web services-management (WSMAN) protocol can be used for communication between the MSM console 121 and the BMC 123.

The DGCE engine 131 establishes a communication channel between the EC 122 using, for example, a functional server and messaging library utility. A functional server utility can be a program to validate transactions and update databases. In illustrative embodiments, the functional server utility records and updates error flags and returns error messages in connection with calls to a server. For example, the errors may be the result of time configurations between chassis components that are different (e.g., do not match). In illustrative embodiments, the messaging library utility provides a message queue, and can run without a dedicated message broker. A messaging library API provides sockets, each socket representing a many-to-many connection between endpoints. A non-limiting example of a messaging library is the ZeroMQ messaging library.

In illustrative embodiments, the CTS module 130 is located in an internal memory of the chassis such as, for example, the restore serial peripheral interface (rSPI) card and uses the DGCE engine 131 to collect time configuration data. The DGCE engine 131 allocates a storage space in the rSPI card for the collected data and stores the collected data in the newly allocated storage space in the rSPI. In illustrative embodiments, the rSPI card is a flash device that also stores information about a system's service tag, a system's configuration and/or a BMC (e.g., iDRAC) license.

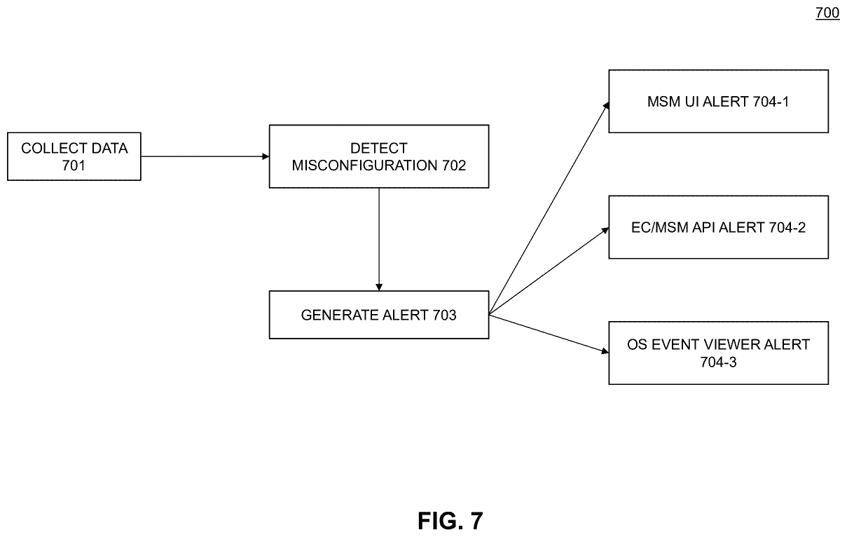

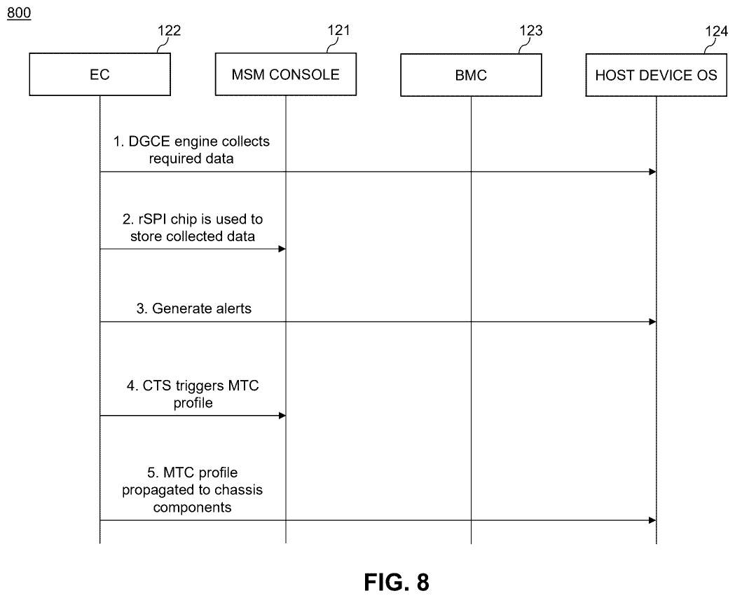

Referring to block 701 of the operational flow 700 in FIG. 7 and to step 1 of the workflow 800 in FIG. 8, the DGCE engine 131 collects time configuration data from the MSM console 121, EC 122, BMC 123 and the host device OS 124. Referring to step 2 in the workflow 800, the collected data is stored in the allocated storage space (e.g., rSPI card). According to one or more embodiments, the allocated storage space (e.g., rSPI card) can be in the MSM console 121. In illustrative embodiments, the time configuration data comprises one or more settings, including, for example, time zone identification (e.g., UTC +1, GMT +5.30, GMT −4, CST, CDT, etc.), geographic location, current system time and date, whether NTP or another time protocol is being used, a time source (e.g., local clock), whether time and/or time zone can be automatically set, whether adjustments for daylight savings time can be made, time protocol (e.g., NTP) server identifiers, etc.

Referring to block 702 of the operational flow 700, the time protocol misconfiguration detection and alerting engine 132 analyzes the time configuration data to determine whether two or more of the chassis components (e.g., MSM console 121, EC 122, BMC 123, host device OS 124 and other chassis components 125) have different time configurations from each other. In other words, time protocol misconfiguration detection and alerting engine 132 analyzes the collected data and detects whether there are different time settings between at least two of the chassis components. Referring to block 703 of the operational flow 700 and to step 3 of the workflow 800, in the event of a detected time misconfiguration between chassis components, the time protocol misconfiguration detection and alerting engine 132 generates one or more alerts about the time configuration differences, which can be sent to one or more users. In more detail, in response to a detected time misconfiguration, the time protocol misconfiguration detection and alerting engine 132 generates one or more notifications identifying the chassis components having different time configurations from each other. In illustrative embodiments, the notifications include one or more logs including the time configuration data from the chassis components. As can be seen in blocks 704-1, 704-2 and 704-3 in FIG. 7, the notifications (alerts) can be provided to a user via an MSM UI, EC/MSM API (e.g., Redfish®, REST) and/or an OS event viewer. The notifications (alerts) can also be provided to a user via a remote access controller user interface and/or a command line interface (CLI).

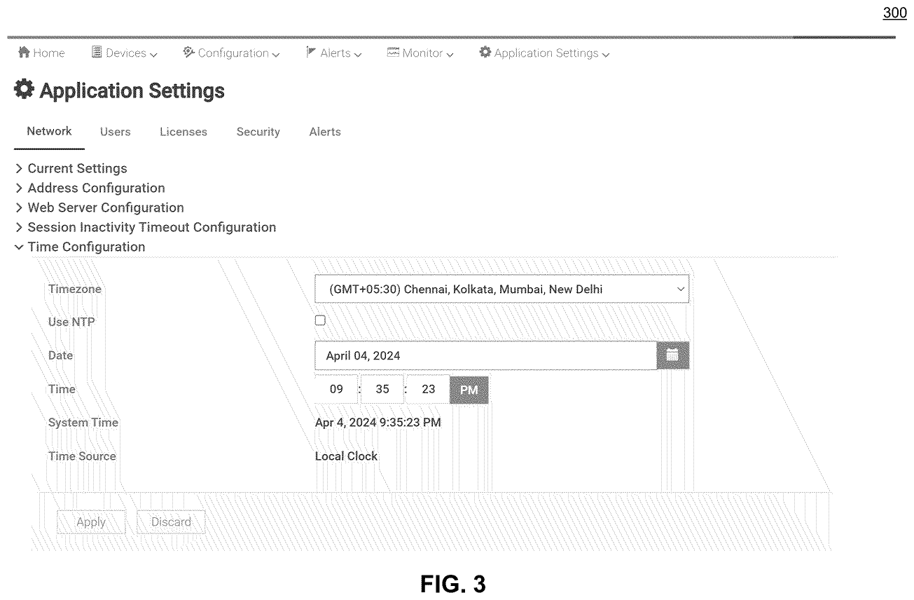

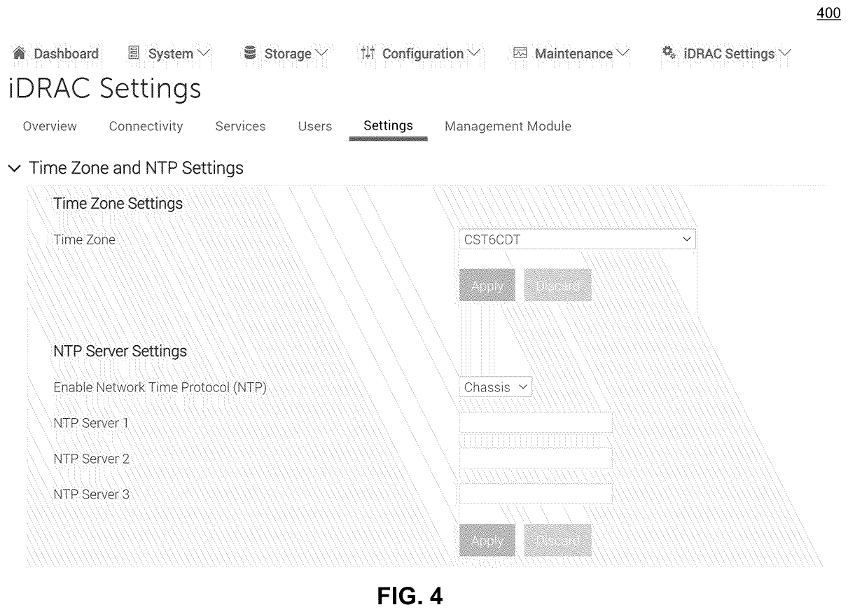

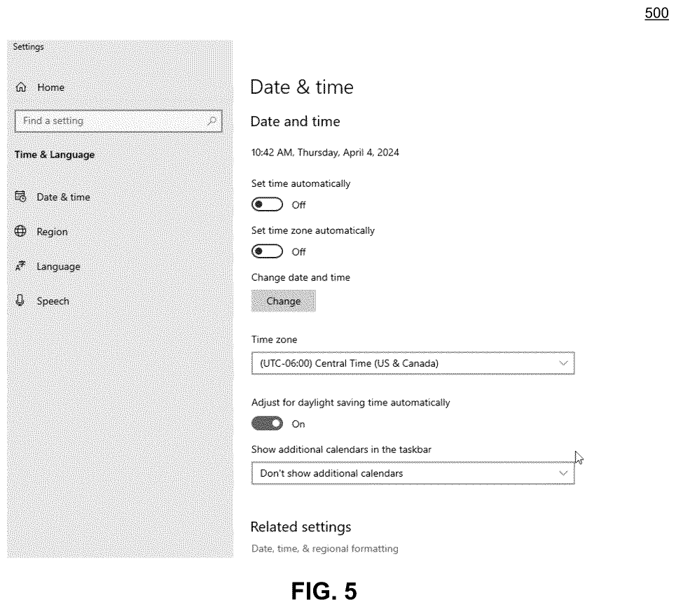

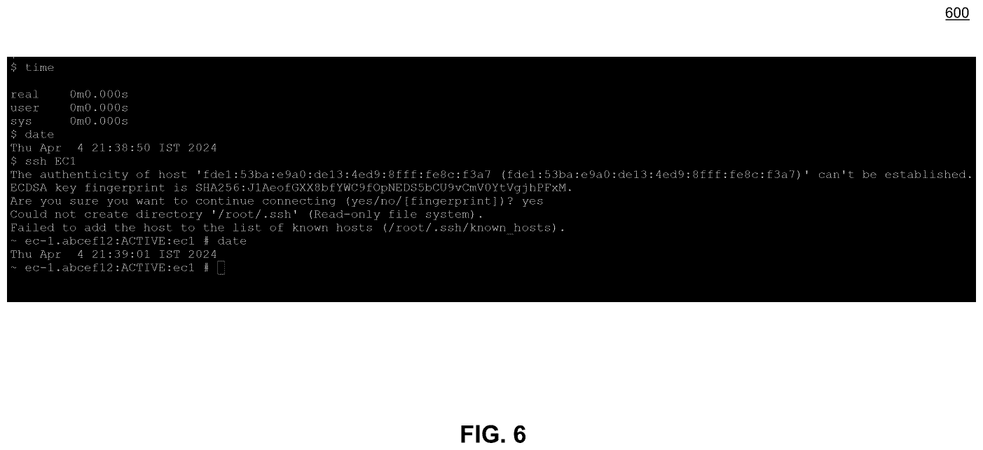

For example, FIG. 3 depicts a screenshot 300 of an MSM UI for viewing and/or configuring time settings of an MSM. FIG. 4 depicts a screenshot 400 a remote access controller user interface for viewing and/or configuring time settings of an RAC. FIG. 5 depicts a screenshot 500 of an OS event viewer to view and/or configure time settings of a host device OS. FIG. 6 depicts a screenshot 600 of a CLI for viewing and/or configuring time settings of an EC.

In illustrative embodiments, the MSM UI in the screenshot 300 shows time configuration settings including time zone identification, geographic location, current system time and date, whether NTP is to be used and a time source (e.g., local clock). The remote access controller user interface in the screenshot 400 shows time configuration settings including time zone identification, where the NTP should enabled (e.g., chassis) and time protocol (e.g., NTP) server identifiers. The OS event viewer in the screenshot 500 shows time configuration settings including time zone identification, geographic location, current system time and date, whether time and/or time zone can be automatically set and whether adjustments for daylight savings time can be made. The CLI in the screenshot 600 shows time configuration settings including current system time and date.

Referring to step 4 in the workflow 800, in response to detecting whether there are different time settings between at least two of the chassis components, the MTC profile creation engine 133 is triggered to generate an MTC profile. The MTC profile comprises one or more time settings (e.g., NTP settings) such as, for example, time zone identification, geographic location, current system time and date, whether NTP or another time protocol is being used, a time source (e.g., local clock), whether time and/or time zone can be automatically set, whether adjustments for daylight savings time can be made, time protocol (e.g., NTP) server identifiers, etc. The MTC profile comprises an ideal time configuration (e.g., NTP time configuration) that will be configured for all chassis components and ensures time configuration synergy between the chassis components.

Referring to step 5 in the workflow 800, the MTC is propagated to the chassis components (e.g., MSM console 121, EC 122, BMC 123, host device OS 124 and other chassis components 125), which are configured to respectively apply the MTC profile to synchronize time settings between the chassis components. In some embodiments, the MTC profile is sent to one or more users (e.g., administrators) via, for example, one or more user devices 102 before being propagated to the chassis components. A user can modify or configure settings of the MTC profile, and the MTC profile configured by the user can then be propagated to the chassis components. Configuration and/or modification of the MTC profile settings may be performed via one or more of the interfaces discussed herein such as, for example, the interfaces shown in the screenshots 300, 400, 500 and 600 of FIGS. 3-6.

According to one or more embodiments, the rSPI card, memories and other data repositories or databases referred to herein can be configured according to a relational database management system (RDBMS) (e.g., PostgreSQL). In some embodiments, rSPI card, memories and other data repositories or databases referred to herein are implemented using one or more storage systems or devices associated with the platform for implementing a common time configuration between chassis components. In some embodiments, one or more of the storage systems utilized to implement databases, memories and other data repositories referred to herein comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

The platform for implementing a common time configuration between chassis components comprising the CTS module 130 including the DGCE engine 131, the time protocol misconfiguration detection and alerting engine 132 and the MTC profile creation engine 133 is assumed to be implemented using at least one processing device. Each such processing device generally comprises at least one processor and an associated memory, and implements one or more functional modules for controlling certain features of the platform for implementing a common time configuration between chassis components.

At least portions of the platform for implementing a common time configuration between chassis components comprising the CTS module 130 including the DGCE engine 131, the time protocol misconfiguration detection and alerting engine 132 and/or the MTC profile creation engine 133 and the elements thereof may be implemented at least in part in the form of software that is stored in memory and executed by a processor. The platform for implementing a common time configuration between chassis components and the elements thereof comprise further hardware and software required for running the platform for implementing a common time configuration between chassis components, including, GPU hardware, virtualization infrastructure software and hardware, Docker containers, networking software and hardware, and cloud infrastructure software and hardware.

It is assumed that the platform for implementing a common time configuration between chassis components and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or Linux containers (LXCs), or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the platform for implementing a common time configuration between chassis components comprising the CTS module 130 including the DGCE engine 131, the time protocol misconfiguration detection and alerting engine 132 and/or the MTC profile creation engine 133, and the elements thereof can be implemented in the form of one or more LXCs running on one or more VMs. Other arrangements of one or more processing devices of a processing platform can be used to implement the platform for implementing a common time configuration between chassis components. Other portions of the system 100 can similarly be implemented using one or more processing devices of at least one processing platform.

It is to be appreciated that these and other features of illustrative embodiments are presented by way of example only, and should not be construed as limiting in any way. Accordingly, different numbers, types and arrangements of system elements such as the CTS module 130 including the DGCE engine 131, the time protocol misconfiguration detection and alerting engine 132 and/or the MTC profile creation engine 133 and other elements of the platform for implementing a common time configuration between chassis components, and the portions thereof can be used in other embodiments.

It should be understood that the particular sets of modules and other elements implemented in the system 100 as illustrated in FIG. 1 are presented by way of example only. In other embodiments, only subsets of these elements, or additional or alternative sets of elements, may be used, and such elements may exhibit alternative functionality and configurations.

For example, as indicated previously, in some illustrative embodiments, functionality for the platform for implementing a common time configuration between chassis components can be offered to cloud infrastructure customers or other users as part of FaaS, CaaS and/or PaaS offerings.

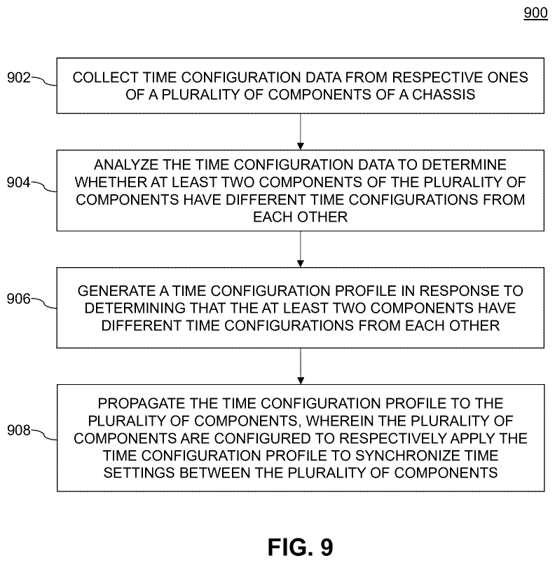

The operation of the information processing system 100 will now be described in further detail with reference to the flow diagram of FIG. 9. With reference to FIG. 9, a process 900 for implementing a common time configuration between chassis components as shown includes steps 902 through 908, and is suitable for use in the information processing system 100 but is more generally applicable to other types of information processing systems or architectures comprising a platform for implementing a common time configuration between chassis components.

In step 902, time configuration data from respective ones of a plurality of components of a chassis is collected. The plurality of components comprise two or more of an MSM console, an EC, a BMC and an OS of at least one host device corresponding to the plurality of components. The BMC can comprise a remote access controller. The time configuration data comprises one or more NTP settings. The time configuration data can be stored in an SPI card (e.g., rSPI card) of the chassis.

In step 904, the time configuration data is analyzed to determine whether at least two components of the plurality of components have different time configurations from each other. In step 906, an MTC profile is generated in response to determining that the at least two components have different time configurations from each other. One or more notifications identifying the at least two components having different time configurations from each other can be generated. The one or more notifications may comprise one or more logs including the time configuration data from the respective ones of a plurality of components. At least one of MSM UI, an RAC UI, an EC API, an MSM API and an OS event viewer may be utilized to provide the one or more notifications to at least one user.

In step 908, the MTC profile is propagated to the plurality of components, wherein the plurality of components are configured to respectively apply the MTC profile to synchronize time settings between the plurality of components. The MTC profile comprises one or more NTP settings. Access can be provided for at least one user to modify the MTC profile before propagating the MTC profile to the plurality of components.

A communication channel structure connecting each of the plurality of components can be established, wherein the communication channel structure comprises at least one passthrough channel. The communication channel structure further comprises one or more communication channels utilizing at least one of a web services-management protocol, an API URI and an RAC CLI utility.

It is to be appreciated that the FIG. 9 process and other features and functionality described above can be adapted for use with other types of information systems configured to implement a common time configuration between chassis components or other type of platform.

The particular processing operations and other system functionality described in conjunction with the flow diagram of FIG. 9 are therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 9 can be implemented at least in part in the form of one or more software programs stored in memory and executed by a processor of a processing device such as a computer or server. The SPI card (e.g., rSPI) comprises at least a portion of the memory to which the processor of the processing device is operatively coupled. As will be described below, a memory or other storage device having executable program code of one or more software programs embodied therein is an example of what is more generally referred to herein as a “processor-readable storage medium.”

Illustrative embodiments of systems with a platform for implementing a common time configuration between chassis components as disclosed herein can provide a number of significant advantages relative to conventional arrangements. For example, the embodiments provide a technical solution including a framework that creates an MTC profile that ensures the time configuration synergy for chassis components. Advantageously, the embodiments use a DGCE engine to collect establish end-to-end communication between chassis components and collect required operational data corresponding to time configuration settings from the chassis components. The time configuration data is stored in a newly allocated storage space (e.g., rSPI chip).

Unlike conventional approaches, the embodiments identify and remediate timing configuration mismatches between chassis components. As a result, issues such as, for example, firmware update failures for chassis components, problems with inventorying chassis components, problems chassis component job scheduling and event correlation and security loopholes, can be prevented.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors.

Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the platform for implementing a common time configuration between chassis components or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a common time configuration platform in illustrative embodiments. These and other cloud-based systems in illustrative embodiments can include object stores.

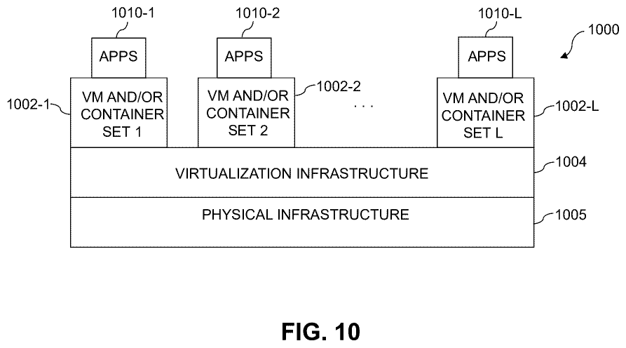

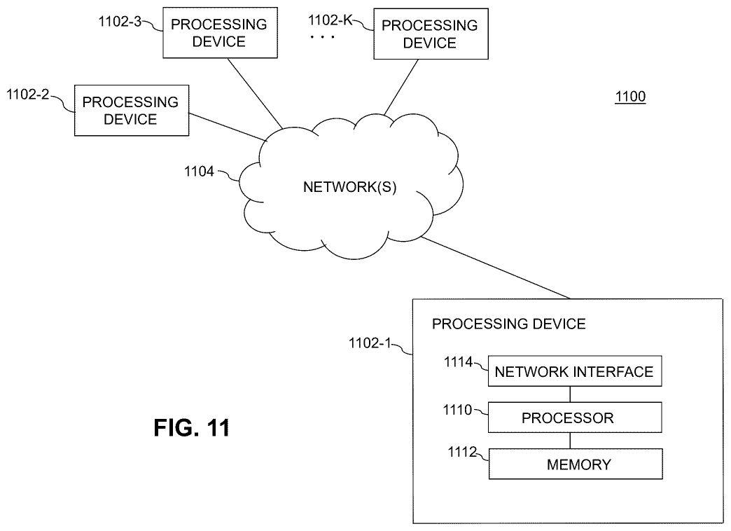

Illustrative embodiments of processing platforms will now be described in greater detail with reference to FIGS. 10 and 11. Although described in the context of information processing system 100, these platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that may be utilized to implement at least a portion of the information processing system 100. The cloud infrastructure 1000 comprises multiple virtual machines (VMs) and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 may comprise respective VMs, respective sets of one or more containers, or respective sets of one or more containers running in VMs.

In some implementations of the FIG. 10 embodiment, the VMs/container sets 1002 comprise respective VMs implemented using virtualization infrastructure 1004 that comprises at least one hypervisor. A hypervisor platform may be used to implement a hypervisor within the virtualization infrastructure 1004, where the hypervisor platform has an associated virtual infrastructure management system. The underlying physical machines may comprise one or more distributed processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing system 100 may each run on a computer, server, storage device or other processing platform element. A given such element may be viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises a portion of system 100 and includes a plurality of processing devices, denoted 1102-1, 1102-2, 1102-3, . . . 1102-K, which communicate with one another over a network 1104.

The network 1104 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1102-1 in the processing platform 1100 comprises a processor 1110 coupled to a memory 1112. The processor 1110 may comprise a microprocessor, a microcontroller, an application-specific integrated circuit (ASIC), a field-programmable gate array (FPGA), a CPU, a GPU, a TPU, a VPU or other type of processing circuitry, as well as portions or combinations of such circuitry elements.

The memory 1112 may comprise random access memory (RAM), read-only memory (ROM), flash memory or other types of memory, in any combination. The memory 1112 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the platform for implementing a common time configuration between chassis components as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and configuration management platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
collecting time configuration data from respective ones of a plurality of components of a chassis;
analyzing the time configuration data to determine whether at least two components of the plurality of components have different time configurations from each other;
generating a time configuration profile in response to determining that the at least two components have different time configurations from each other; and
propagating the time configuration profile to the plurality of components, wherein the plurality of components are configured to respectively apply the time configuration profile to synchronize time settings between the plurality of components;
wherein the steps of the method are executed by at least one processing device operatively coupled to a memory.

2. The method of claim 1 wherein the plurality of components comprise two or more of a multi-system management console, an embedded controller, a baseboard management controller and an operating system of at least one host device corresponding to the plurality of components.

3. The method of claim 2 wherein the baseboard management controller comprises a remote access controller.

4. The method of claim 1 wherein the time configuration data comprises one or more network time protocol settings.

5. The method of claim 1 wherein the time configuration profile comprises one or more network time protocol settings.

6. The method of claim 1 further comprising storing the time configuration data in a serial peripheral interface card of the chassis.

7. The method of claim 6 wherein the serial peripheral interface card comprises at least a portion of the memory to which the at least one processing device is operatively coupled.

8. The method of claim 1 further comprising generating one or more notifications identifying the at least two components having different time configurations from each other.

9. The method of claim 8 wherein the one or more notifications comprise one or more logs including the time configuration data from the respective ones of a plurality of components.

10. The method of claim 8 further comprising utilizing at least one of a multi-system management user interface, a remote access controller user interface, an embedded controller application programming interface, a multi-system management application programming interface and an operating system event viewer to provide the one or more notifications to at least one user.

11. The method of claim 1 further comprising providing access for at least one user to modify the time configuration profile before propagating the time configuration profile to the plurality of components.

12. The method of claim 1 further comprising establishing a communication channel structure connecting each of the plurality of components, wherein the communication channel structure comprises at least one passthrough channel.

13. The method of claim 12 wherein the communication channel structure further comprises one or more communication channels utilizing at least one of a web services-management protocol, an application programming interface uniform resource identifier and a remote access controller command-line utility.

14. An apparatus comprising:
a processing device operatively coupled to a memory and configured:
to collect time configuration data from respective ones of a plurality of components of a chassis;
to analyze the time configuration data to determine whether at least two components of the plurality of components have different time configurations from each other;
to generate a time configuration profile in response to determining that the at least two components have different time configurations from each other; and
to propagate the time configuration profile to the plurality of components, wherein the plurality of components are configured to respectively apply the time configuration profile to synchronize time settings between the plurality of components.

15. The apparatus of claim 14 wherein the processing device is further configured to generate one or more notifications identifying the at least two components having different time configurations from each other.

16. The apparatus of claim 14 wherein the processing device is further configured to establish a communication channel structure connecting each of the plurality of components, wherein the communication channel structure comprises at least one passthrough channel.

17. The apparatus of claim 16 wherein the communication channel structure further comprises one or more communication channels utilizing at least one of a web services-management protocol, an application programming interface uniform resource identifier and a remote access controller command-line utility.

18. An article of manufacture comprising a non-transitory processor-readable storage medium having stored therein program code of one or more software programs, wherein the program code when executed by at least one processing device causes said at least one processing device to perform the steps of:
collecting time configuration data from respective ones of a plurality of components of a chassis;
analyzing the time configuration data to determine whether at least two components of the plurality of components have different time configurations from each other;
generating a time configuration profile in response to determining that the at least two components have different time configurations from each other; and
propagating the time configuration profile to the plurality of components, wherein the plurality of components are configured to respectively apply the time configuration profile to synchronize time settings between the plurality of components.

19. The article of manufacture of claim 18 wherein the program code further causes said at least one processing device to establish a communication channel structure connecting each of the plurality of components, wherein the communication channel structure comprises at least one passthrough channel.

20. The article of manufacture of claim 19 wherein the communication channel structure further comprises one or more communication channels utilizing at least one of a web services-management protocol, an application programming interface uniform resource identifier and a remote access controller command-line utility.
